(19) United States
(12) Patent Application Publication
(10) Pub. No.: US 2023/0100163 A1
(43) Pub. Date: Mar. 30, 2023

(54) ALLOCATING COMPUTING DEVICE RESOURCES

(71) Applicant: Google LLC, Mountain View, CA (US)

(72) Inventor: Kweku Adams, Mountain View, CA (US)

(21) Appl. No.: 17/448,737

(22) Filed: Sep. 24, 2021

(51) Int. Cl. G06F 9/50; G06F 9/48

(52) U.S. Cl. CPC G06F 9/5038; G06F 9/4881

(57) ABSTRACT

Techniques are disclosed for allocating resources of a computing device. An operating system executing at the computing device may receive a request for the computing device to execute a task associated with an application installed at the computing device and determine a resource cost associated with executing the task. In various examples, the operating system further determines, based on the application, an amount of resources available for executing the task and schedules the task to be executed at the computing device. Responsive to determining that the amount of resources available to execute the task is sufficient given the resource cost associated with the task, the computing device may execute the task based on the schedule.

### BACKGROUND

One or more applications installed at a computing device may send a request to an operating system (“OS”) of the computing device to execute a task. For example, an entertainment application may automatically send a request to the OS for the computing device to download a movie in the background. Such background tasks may consume resources of the computing device, such as battery power, processor cycles, network bandwidth, and the like. In some instances, the user may not be aware that the computing device is performing such background tasks and the background tasks may consume more resources than desired (e.g., by prematurely depleting the battery).

### SUMMARY

The techniques of this disclosure are directed to enabling a computing device to execute a task based on a resource cost associated with executing the task relative to an amount of resources available for executing the task. In general, a computing device may execute every task requested by one or more applications installed at the computing device. As a result, the computing device may allocate resources to executing tasks that are not important (e.g., to a user of the computing device) and consequently have insufficient resources for executing tasks that are important. This may not only interfere with usage of the computing device (e.g., by forcing the user to recharge the computing device), and thus adversely affect the user experience of the computing device, but also increase charge cycles of the battery, which may eventually result in diminished battery performance (e.g., decreased battery lifespan).

Rather than executing each request for a task irrespective of an importance of the task, the computing device may determine the resource cost associated with executing the task, determine an amount of resources available for executing the task, and, responsive to determining that there are sufficient resources available to execute the task given the resource cost of the task, schedule and execute the task. In other examples, the system may schedule the task even when there are not sufficient resources but may not execute the task until there are sufficient resources. Both the resource cost and the amount of resources available may be based on a variety of factors, at least some of which may relate to the importance of the task.

In this way, various aspects of the techniques may enable the computing device to more efficiently allocate resources to tasks that are of greater importance. Prioritizing tasks in this manner may thus reduce power usage of the computing device and, in some examples, bandwidth and processor usage of the computing device. Specifically, by not executing a task when the resource cost associated with executing the task is greater than the amount of resources available for executing the task (in this way indicating that the task is not important), the computing device may reduce power, processor, and/or bandwidth usage.

In some examples, a method includes: receiving, by an operating system executing at a computing device, a request for the operating system to execute a task associated with an application installed at the computing device; determining, by the operating system, a resource cost associated with executing the task; determining, by the operating system and based on the application, an amount of resources available for executing the task; scheduling, by the operating system, the task to be executed at the computing device; and responsive to determining that the amount of resources available for executing the task is sufficient given the resource cost associated with executing the task, executing, by the operating system and based on the schedule, the task.

In some examples, a computing device includes: one or more processors; a memory that stores an operating system and instructions that, when executed by the one or more processors, cause the one or more processors to: receive a request for the operating system to execute a task associated with an application installed at the computing device; determine a resource cost associated with executing the task; determine, based on the application, an amount of resources available for executing the task; schedule the task to be executed at the computing device; and responsive to determining that the amount of resources available to execute the task is sufficient given the resource cost associated with the task, execute, based on the schedule, the task.

In some examples, a non-transitory computer-readable storage medium is encoded with instructions that, when executed by one or more processors of a computing device, cause the one or more processors to: receive a request for an operating system of the computing device to execute a task associated with an application installed at the computing device; determine a resource cost associated with executing the task; determine, based on the application, an amount of resources available for executing the task; schedule the task to be executed at the computing device; and responsive to determining that the that the amount of resources available to execute the task is sufficient given the resource cost associated with the task, execute, based on the schedule, the task.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing device for allocating resources in accordance with techniques of this disclosure.

FIG. 2 is a conceptual diagram illustrating further details of an example computing device for allocating resources in accordance with techniques of this disclosure.

FIGS. 3A and 3B are conceptual diagrams illustrating an example resource cost repository and an example resource availability repository in accordance with techniques of this disclosure.

FIG. 4 is a flowchart illustrating an example operation of the computing device in accordance with techniques of this disclosure.

### DETAILED DESCRIPTION

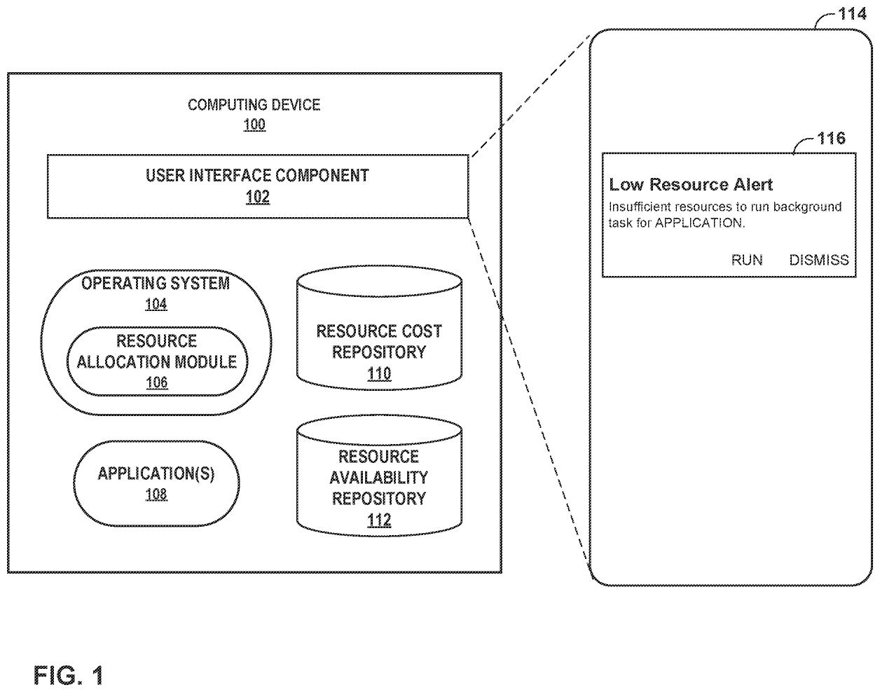

FIG. 1 is a conceptual diagram illustrating an example computing device 100 for allocating resources in accordance with techniques of this disclosure. In the example of FIG. 1, computing device 100 represents an individual mobile or non-mobile computing device. Examples of computing device 100 include a mobile phone, a tablet computer, a laptop computer, a desktop computer, a server, a mainframe, a set-top box, a television, a wearable device (e.g., a computerized watch, computerized eyewear, computerized headphones, computerized gloves, etc.), a home automation device or system (e.g., an intelligent thermostat or home assistant device), a personal digital assistant (PDA), a gaming system, a media player, an e-book reader, a mobile television platform, an automobile navigation or infotainment system, or any other type of mobile, non-mobile, wearable, and non-wearable computing device configured to allocate resources in accordance with techniques of this disclosure.

Computing device 100 includes a user interface component (“UIC”) 102, an operating system 104 (“OS 104”) that includes a resource allocation module 106, one or more applications 108, a resource cost repository 110, and a resource availability repository 112. OS 104 and applications 108 may perform operations described herein using software, hardware, firmware, or a mixture of hardware, software, and firmware residing in and/or executing at computing device 100. Computing device 100 may execute OS 104 and applications 108 with multiple processors or multiple devices, as virtual machines executing on underlying hardware, as one or more services of an operating system or computing platform, and/or as one or more executable programs at an application layer of a computing platform of computing device 100.

UIC 102 of computing device 100 may function as an input and/or output device for computing device 100. UIC 102 may be implemented using various technologies. For instance, UIC 102 may function as an input device using presence-sensitive input screens, microphone technologies, infrared sensor technologies, or other input device technology for use in receiving user input. UIC 102 may function as an output device configured to present output to a user using any one or more display devices, speaker technologies, haptic feedback technologies, or other output device technology for use in outputting information to a user.

UIC 102 may detect input (e.g., touch and non-touch input) from a user of computing device 100. UIC 102 may detect indications of input by detecting one or more gestures performed by a user (e.g., the user touching, pointing, and/or swiping at or near one or more locations of UIC 102 with a finger or a stylus pen). UIC 102 may output information to a user in the form of a user interface 114 (“UI 114”), which may be associated with functionality provided by computing device 100.

As shown in the example of FIG. 1, computing device 100 includes OS 104. OS 104 may provide an execution environment for one or more modules, such as resource allocation module 106, and one or more applications, such as applications 108. OS 104 may represent a multi-threaded operating system or a single-threaded operating system with which resource allocation module 106 and applications 108 may interface to access hardware of computing device 100. OS 104 may include a kernel that facilitates access to the underlying hardware of computing device 100, where kernel may present a number of different interfaces (e.g., application programmer interfaces (APIs)) that resource allocation module 106 and applications 108 may invoke to access the underlying hardware of computing device 100.

Resource allocation module 106 of OS 104 may perform functions associated with handling requests for OS 104 to execute tasks generated by applications 108. For instance, resource allocation module 106 may schedule tasks by allocating resources, such as processors, network links, expansion cards, central processing unit (CPU) time, battery drain, and memory usage, to perform the tasks. In some examples, resource allocation module 106 may schedule a task such that OS 104 executes the task substantially immediately upon receipt of the corresponding request. In other examples, resource allocation module 106 may schedule the task such that OS 104 executes the task at a later time. In other words, resource allocation module 106 may defer a request to execute a task.

As used throughout this disclosure, the term “tasks” is used to describe instructions stored on a computer-readable storage medium that cause one or more processors of computing device 100 to execute corresponding processes, threads, and/or data flows associated with applications 108. Typically, tasks may be foreground tasks or background tasks. Execution of a foreground task may require a user of computing device 100 to interact with the foreground task (e.g., an application may require a user input to request execution of a foreground task). Conversely, execution of a background task may be independent of the user (e.g., an application may not require a user input to request execution of a background task).

Applications 108 may represent a first party application developed and provided as an application integrated into OS 104 or a third-party application that the user of primary device 100 obtains via application store services provided by way of OS 104. Applications 108 may extend software functionality of primary device 100, where applications 108 may execute within an execution environment presented by OS 104. Applications 108 may, as a few examples, provide gaming services (e.g., video games), email services, web browsing services, texting and/or chat services, web conferencing services, video conferencing services, music services (including streaming music services), video services (including video streaming services), navigation services, word processing services, spreadsheet services, slide and/or presentation services, assistant services, text entry services, or any other service commonly provided by applications. For purposes of this disclosure, applications 108 may include widgets.

One or more of applications 108 may send a request to resource allocation module 106 for OS 104 to execute a task. For example, an entertainment application may send a request to resource allocation module 106 for OS 104 to execute a background task of automatically downloading a movie. Responsive to receiving the request, resource allocation module 106 may schedule the task, and OS 104 may utilize the underlying hardware of computing device 100 to execute the task based on the schedule. In general, hardware components consume resources, such as a charge of a battery of computing device 100, to perform these functions. Thus, a charge level of the battery of computing device 100 (as well as other resources of computing device) may quickly decrease if resource allocation module 106 schedules and OS 104 executes every task requested by applications 108 irrespective of the importance of the task. This may not only interfere with usage of computing device 100 (e.g., by forcing the user to recharge computing device), and thus adversely affect the user experience of the computing device, but may also increase charge cycles of the battery, which may eventually result in diminished battery performance (e.g., decreased battery lifespan).

Rather than executing each task irrespective of the importance of the task, techniques of this disclosure enable OS 104 to execute a task based on whether there are sufficient resources available to execute the task given the resource cost of the task. For example, as described in greater detail below, by executing a task based on whether the resource cost associated with executing the task is less than or equal to an amount of resources available for executing the task, OS 104 may prioritize execution of tasks in accordance with the importance of the tasks, thereby potentially improving the performance and/or the user experience of computing device 100.

Although this disclosure primarily describes OS 104 determining whether there are sufficient resources available to execute a task given the resource cost of the task based on whether the resource cost associated with executing the task is less than or equal to an amount of resources available for executing the task, it should be understood that other configurations are contemplated by this disclosure. For instance, OS 104 may determine whether there are sufficient resources available to execute a task given the resource cost of the task based on whether the amount of resources available for executing the task is equal to or greater than the resource cost associated with executing the task. Thus, the example configuration of OS 104 for determining whether there are sufficient resources is merely for purposes of illustration and is not intended to limit the scope of the claims.

As noted above, responsive to receiving a request for OS 104 to execute a task associated with one of applications 108, resource allocation module 106 may determine a resource cost associated with executing the task. The resource cost may be based on a variety of factors relating to the importance of the task, including, but not limited to, a state of computing device 100, whether the task is a foreground task or a background task, and whether the task was initiated in response to a user input. The resource cost may be measured using any appropriate unit, such as standard units (e.g., watts (W), gigabytes (GB), etc.) as well as non-standard units (e.g., “general resource units (GRUs)”). To some extent, non-standard units may represent one or more physical properties associated with computing device 100, such as power usage, data usage, etc., by computing device 100. Additionally or alternatively, non-standard units may represent the importance of a task (e.g., based on the aforementioned factors).

Resource allocation module 106 may obtain the resource cost for the task from resource cost repository 110. Resource cost repository 110 may include a data structure that associates each task with information indicating the resource cost for the task. In some examples, resource allocation module 106 may access resource cost repository to obtain the resource cost for the task. The value of a resource cost for a task may vary based on a variety of factors, such as whether the task is being performed in the foreground or background of computing device 100, whether computing device 100 is charging, etc. In some cases, a resource cost associated with a task may be equal to a base value adjusted by one or more modifiers, where the one or more modifiers are associated with a respective one or more factors described above. The modifier may adjust the base value via any mathematical operation, including, for example, multiplication, division, addition, subtraction, etc. Accordingly, types of modifiers may include a multiplier, a divider, an adder, a subtractor, etc.

The resource cost associated with a foreground task may be different from the resource cost associated with a background task. For example, the resource cost associated with a foreground task may be less than the resource cost associated with a background task because, in general, foreground tasks (e.g., tasks that were requested in response to user input) may be more important to a user than background tasks (e.g., tasks that were not requested in response to user input). In some examples, the resource cost associated with all foreground tasks may be 0 (e.g., 0 GRUs), in which case OS 104, and more specifically resource allocation module 106, may always determine that there are sufficient resources available to execute foreground tasks. As such, the modifier associated with a task being performed in the foreground may be a multiplier of 0, although it should be understood that other multipliers (e.g., 0.1, 0.5, 0.8, etc.) as well as other types of modifiers (e.g., a divider, an adder, a subtractor, etc.) are contemplated by this disclosure. In some examples, a foreground task may have a reduced resource cost compared to a background task but not a resource cost of 0.

The resource cost associated with a task when computing device 100 is charging may be different from the resource cost associated with the task when computing device 100 is not charging. For example, the resource cost associated with a task when computing device 100 is charging may be less than the resource costs associated with the task when computing device 100 is not charging because, when computing device 100 is charging, resources, such as the charge of a battery of computing device 100, are no longer or less scarce. In some examples, the resource cost associated with a task when computing device 100 is charging may be 0 (e.g., 0 GRUs), in which case OS 104, and more specifically resource allocation module 106, may always determine that there are sufficient resources available to execute the task. As such, the modifier associated with a charging state of computing device 100 may be a multiplier of 0, although it should be understood that other multipliers (e.g., 0.1, 0.5, 0.8, etc.) as well as other types of modifiers (e.g., a divider, an adder, a subtractor, etc.) are contemplated by this disclosure.

Resource allocation module 106 may also determine (and ultimately allocate) an amount of resources available for executing the task. The amount of resources available may be based on a variety of factors relating to the importance of the task, including, but not limited to, an amount of resources already consumed (e.g., by a particular application and/or in total), the state of the computing device, a priority of the task, a frequency of the application requesting the task malfunctioning (e.g., the task timing-out, the application crashing, or other undesirable or unintended behavior), and a user input terminating execution of the application (sometimes referred to as “force stopping”). The amount of resources available may be measured in the same units as the resource cost.

Resource allocation module 106 may obtain the amount of resources available for the task from resource availability repository 112. Resource availability repository 112 may include a data structure that associates each task with information indicating the amount of resources available for executing the task. In some examples, resource allocation module 106 may access resource cost repository to obtain the resource cost for the task.

The priority of a task may be positively correlated to the amount of resources available for the task such that the more important the task, the more the amount of resources available for the task. For example, the amount of resources available for a frequently used application (e.g., as indicated by historical usage rate) to request tasks may be greater than the amount of resources available for a not-frequently used application to request tasks because the tasks performed by a frequently used application may be more important (e.g., from the perspective of a user of computing device 100) than the tasks performed by a not-frequently used application.

In another example, the amount of resources available for an application to request tasks may be greater if the task being requested is important than if the task is not important. Resource allocation module 106 may determine the importance of a task based on, for example, whether the task is related to an alarm, a timer, a calendar reminder, a user-defined setting, etc. Resource allocation module 106 may also determine the importance of a task based on the amount of time the application that requested the task operates in the foreground of computing device 100, the number of notifications generated by the application with which the user interacted, and other user interactions with the application and/or task, such as whether the user has overridden resource allocation module 106 to cause resource allocation module 106 to schedule the task, as described in greater detail below.

Resource allocation module 106 may compare the resource cost associated with executing the task with the amount of resources available for executing the task. Responsive to determining that there are sufficient resources available to execute the task given the resource cost of the task, resource allocation module 106 may schedule the task to be executed at computing device 100. OS 104 may then execute the task based on the schedule.

While described as scheduling a task in response to sufficient resources being available, in other examples resource allocation module 106 may schedule the task even when there are not sufficient resources, but OS 104 may not execute the task until there are sufficient resources. For example, resource allocation module 106 may schedule the task irrespective of whether the amount of resources available for executing the task is sufficient given the resource cost associated with executing the task. Responsive to resource allocation module 106 determining that the amount of resources available for executing the task is sufficient given the resource cost associated with executing the task, OS 104 may execute, based on the schedule, the task.

As an example, an entertainment application may send a request to resource allocation module 106 for OS 104 to execute a background task of automatically downloading a movie. Resource allocation module 106 may access the data structure stored in resource cost repository 110 to obtain the information indicating the resource cost for the background task of automatically downloading the movie. Based on that information, resource allocation module 106 may determine that the resource cost is 50 GRUs.

Additionally, resource allocation module 106 may access the data structure stored in resource availability repository 112 to obtain the information indicating the amount of resources available for the background task of automatically downloading the movie. Based on that information, resource allocation module 106 may determine that the amount of resources available is 75 GRUs. Accordingly, resource allocation module 106 may schedule the background task of automatically downloading a movie because the resource cost of 50 GRUs is less than the amount of resources available of 75 GRUs. OS 104 may then execute the background task of automatically downloading a movie based on the schedule.

When scheduling the task, resource allocation module 106 may allocate resources of computing device 100 corresponding to the resource cost for the task and may adjust the amount of resources available for executing future tasks. The allocation of resources by resource allocation module 106 when scheduling the task may cause a corresponding change in the amount of resources available for executing the task. For instance, using the above example, responsive to resource allocation module 106 scheduling the background task of automatically downloading a movie, the amount of resources available for executing the next task may become 25 GRUs (i.e., 75 GRUs minus 50 GRUs).

Responsive to determining that the resource cost associated with executing the task is greater than the amount of resources available for executing the task, resource allocation module 106 may not schedule the task and OS 104, in turn, may not execute the task. In other examples, resource allocation module 106 may schedule the task even when the resource cost associated with executing the task is greater than the amount of resources available for executing the task, but OS 104 may not execute the task until the resource cost associated with executing the task is equal to or less than the amount of resources available for executing the task.

In some examples, computing device 100 may output a notification 116 via UIC 102 when a task is not executed due to insufficient amount of resources available. A user of computing device 100 may provide a user input, such as a touch input via UIC 102, to dismiss notification 116. Alternatively, the user may provide a user input to override resource allocation module 106, causing resource allocation module 106 to schedule and OS 104 to execute the task. In some examples, when the user overrides resource allocation module 106, resource allocation module 106 may adjust the resource cost associated with executing the task such that there are sufficient resources available to execute the task given the resource cost of the task. For instance, resource allocation module 106 may decrease the resource cost to 0 in response to a user input to override resource allocation module 106. As a result, overriding resource allocation module 106 may not reduce the amount of resources available to perform future tasks. In some examples, an importance of a task may increase in response to the user input to override resource allocation module 106, which may cause resource allocation module 106 to increase the amount of resources available for the application to request the task in the future.

As an example, the entertainment application from the above example may send a request to resource allocation module 106 for OS 104 to execute the background task of automatically downloading a movie. Resource allocation module 106 may access the data structure stored in resource cost repository 110 and determine that the resource cost for this task is 50 GRUs. Resource allocation module 106 may access the data structure stored in resource availability repository 112 and determine that the amount of resources available for executing this task is 25 GRUs. Accordingly, resource allocation module 106 may not schedule the background task of automatically downloading a movie because the resource cost of 50 GRUs is greater than the amount of resources available of 25 GRUs. Additionally, computing device 100 may output notification 116 communicating that the background task of automatically downloading a movie failed to execute due to an insufficient amount of resources available. A user of computing device 100 may then provide a user input to dismiss notification 116 or override resource allocation module 106, thereby causing resource allocation module 106 to schedule and OS 104 to execute the background task.

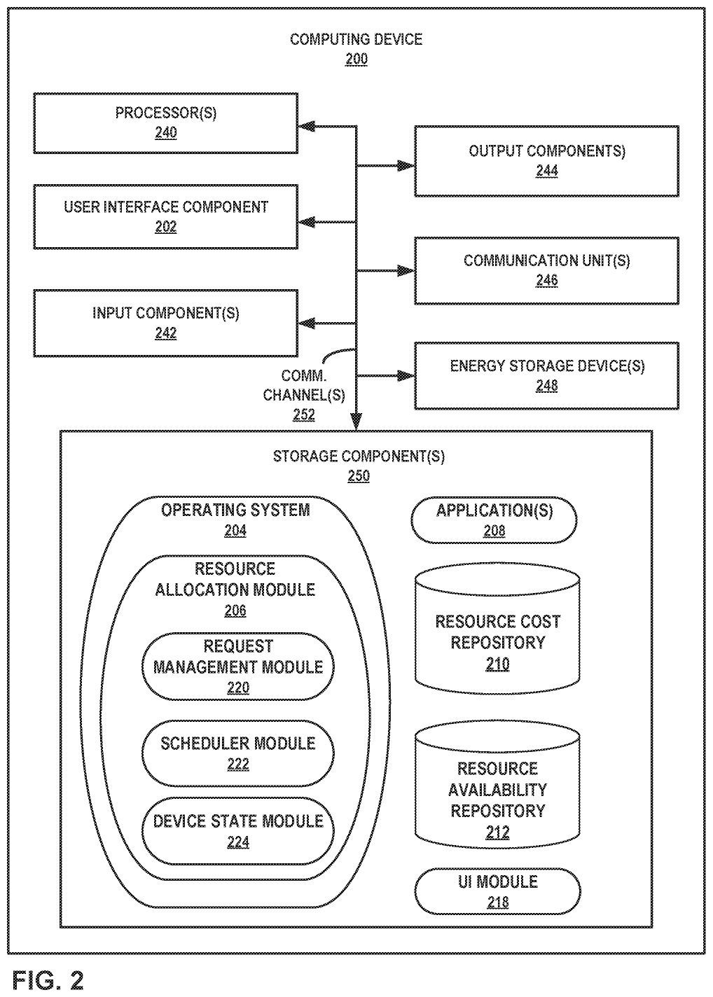

FIG. 2 is a conceptual diagram illustrating further details of a computing device 100 that performs resource allocation, in accordance with one or more techniques of this disclosure. Computing device 200 of FIG. 2 is described below as an example of computing device 100 illustrated in FIG. 1. FIG. 2 illustrates only one particular example of computing device 200, and many other examples of computing device 200 may be used in other instances and may include a subset of the components included in example computing device 200 or may include additional components not shown in FIG. 2.

As shown in the example of FIG. 2, computing device 200 includes UIC 202, one or more processors 240, one or more input components 242, one or more output components 244, one or more communication units 246, one or more energy storage devices 248 (e.g., batteries), and one or more storage components 250. Storage components 250 of computing device 200 include OS 204, resource allocation module 206, applications 208, resource cost repository 210, resource availability repository 212, and a UI module 218. Resource allocation module 206 includes a request management module 220, a scheduler module 222, and a device state module 224.

Communication channels 252 may interconnect each of the components 240, 202, 242, 244, 246, 248, and/or 250 for inter-component communications (physically, communicatively, and/or operatively). In some examples, communication channels 252 may include a system bus, a network connection, an inter-process communication data structure, or any other method for communicating data.

One or more input components 242 of computing device 200 may receive input. Examples of input are tactile, audio, and video input. Input components 242 of computing device 200, in one example, includes a presence-sensitive display, touch-sensitive screen, mouse, keyboard, voice responsive system, video camera, microphone or any other type of device for detecting input from a human or machine.

One or more output components 244 of computing device 200 may generate output. Examples of output are tactile, audio, and video output. Output components 244 of computing device 200, in one example, includes a presence-sensitive display, sound card, video graphics adapter card, speaker, cathode ray tube (CRT) monitor, liquid crystal display (LCD), haptic motors, linear actuating devices, or any other type of device for generating output to a human or machine.

One or more communication units 246 of computing device 200 may communicate with external devices via one or more wired and/or wireless networks by transmitting and/or receiving network signals on the one or more networks. Examples of communication units 246 include a network interface card (e.g., an Ethernet card), an optical transceiver, a radio frequency transceiver, a GPS receiver, or any other type of device that can send and/or receive information. Other examples of communication units 246 may include short wave radios, cellular data radios, wireless network radios, as well as universal serial bus (USB) controllers.

UIC 102 of computing device 200 may be hardware that functions as an input and/or output device for computing device 200. For example, UIC 202 may include a display component, which may be a screen at which information is displayed by UIC 202 and a presence-sensitive input component that may detect an object at and/or near the display component.

One or more processors 240 may implement functionality and/or execute instructions within computing device 200. For example, processors 240 on computing device 200 may receive and execute instructions stored by storage components 250 that execute the functionality of modules 206, 218, 220, 222, and 224 and applications 208. The instructions executed by processors 240 may cause computing device 200 to store information within storage components 250 during program execution. Examples of processors 240 include application processors, display controllers, sensor hubs, and any other hardware configured to function as a processing unit. Processors 240 may execute instructions of modules 206, 218, 220, 222, and 224 and applications 208 to perform various actions or functions of computing device 200.

One or more storage components 250 within computing device 200 may store information for processing during operation of computing device 200 (e.g., computing device 200 may store data accessed by modules 206, 218, 220, 222, and 224 and applications 208 during execution at computing device 200). In some examples, storage components 250 may be configured for temporary memory, meaning that a primary purpose of storage components 250 is not long-term storage. Storage components 250 on computing device 200 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 250, in some examples, also include one or more computer-readable storage media. Storage components 250 may be configured to store larger amounts of information than volatile memory. Storage components 250 may further be configured for long-term storage of information as non-volatile memory space and retain information after power on/off cycles. Examples of non-volatile memories include magnetic hard discs, optical discs, flash memories, or forms of electrically programmable memories (EPROM) or electrically erasable and programmable (EEPROM) memories. Storage components 250 may store program instructions and/or information (e.g., data) associated with modules 206, 218, 220, 222, and 224 and applications 208. Resource allocation module 206 and applications 208 may execute at processors 240 to perform functions similar to those of resource allocation module 106 and applications 108 of FIG. 1.

Request management module 220 may perform functions associated with receiving, managing, and otherwise handling requests for OS 104 to execute tasks generated by applications 108. For example, request management module 220 may receive requests from applications 208 for OS 204 to output a notification, monitor for receipt of a communication message (e.g., e-mail, instant message, text message, etc.), request information from a remote server, upload analytics, download content, perform operations related to media playback (e.g., music playback, video playback, etc.), generate a reminder (e.g., an alert) of a calendar event (meetings, appointments, etc.), update software, enable inter-component communications between two or more components of platforms, applications, and/or services executing at computing device 200, etc.

Scheduler module 222 may schedule tasks by assigning resources, such as processors, network links, and expansion cards, to perform the tasks. Scheduler module 222 may be part of OS 204 and may decide which task executes at a certain point in time. For example, scheduler module 222 may have the ability to start the execution of a task, stop the execution of a task, and move a position of a task in a queue of tasks. Accordingly, scheduler module 222 may allow, store, defer, deny, and otherwise handle requests from applications for OS 204 to perform tasks in order to allocate resources of computing device 200. Scheduler module 222 may employ a scheduling algorithm in accordance with techniques of this disclosure for distributing resources of computing device 200 among tasks that simultaneously or asynchronously request the resources.

Device state module 224 may determine a state of computing device 200, such as a power state, a charging state (i.e., whether computing device 200 is charging), a charge state (i.e., a charge level of energy storage devices 248), etc. Example power states of computing device 200 include a full-power state, low-power states, etc. The full-power state may be the highest-performance, most functional state of computing device 200 and thus have the greatest power consumption. The low-power states may be relatively low performance, less functional states and thus have less power consumption. Example low-power states include a battery saving state (sometimes referred to as a low power mode), a standby state, a sleep state, an off state, etc.

Resource allocation module 206 of OS 204 may execute a task based on whether there are sufficient resources available to execute the task given the resource cost of the task. For example, request management module 220 may receive a request for OS 204 to execute a task associated with one of applications 208. Responsive to request management module 220 receiving the request, scheduler module 222 may determine a resource cost associated with executing the task by obtaining the resource cost for the task from resource cost repository 210 and an amount of resources available for the task from resource availability repository 212. Responsive to determining that the resource cost associated with executing the task is less than or equal to the amount of resources available for executing the task, scheduler module 222 may schedule the task to be executed at computing device 200. OS 204 may then execute the task based on the schedule.

In some examples, scheduler module 222 may determine the amount of resources available for executing a task based on a respective amount of resources available for the application associated with the task and an amount of resources previously used by the application. For instance, scheduler module 222 may determine a total amount of resources available for executing tasks and further determine, based on the total amount of resources, a respective initial amount of resources available for each application of applications 208.

As an example, scheduler module 222 may determine that the total amount of resources available for executing tasks at computing device is 300 GRUs. Scheduler module 222 may allocate a portion of the 300 total GRUs to each application of applications 208 such that the sum of the allocated GRUs is less than or equal to 300 GRUs, in this way establishing an initial amount of resources available for each application of applications 208. For instance, a first application, a second application, and a third application may each be allocated 100 GRUs. It should be understood that the initial amount of resources of 300 GRUs and/or the distribution of the resources to each of applications 208 are arbitrary and that other initial amounts of resources and/or other distributions of the resources are contemplated by this disclosure.

The first application may request for OS to execute a task with a resource cost of 50 GRUs, the second application may request to execute a task with a resource cost of 75 GRUs, and the third application may request to execute a task with a resource cost of 100 GRUs. Scheduler module 222 may schedule these tasks for the corresponding applications, causing corresponding changes in the amount of resources available for each application for executing tasks. That is, in this example, the amount of resources available for the first application may now be 50 GRUs because the first application previously used 50 GRUs of the initial amount of 100 GRUs, the amount of resources available for the second application may now be 25 GRUs because the second application previously used 75 GRUs of the initial amount of 100 GRUs, and the amount of resources available for the third application may now be 0 GRUs because the third application previously used 100 GRUs of the initial amount of 100 GRUs.

When applications consume resources to execute tasks, scheduler module 222 may record the amount of resources consumed and redistribute resources based on the amount of resources consumed. For instance, in the above example where a total of 225 GRUs were used by the first application, the second application, and the third application, scheduler module 222 may record that a total of 225 GRUs have been consumed and require redistribution. Scheduler module 222 may then allocate a portion of the 225 GRUs to each application of applications 208 such that the sum of the allocated GRUs is less than or equal to 225 GRUs.

In some examples, scheduler module 222 may determine the total amount of resources available for executing tasks based on one or more of a capacity of energy storage devices 248 of computing device 200 or a charge level of energy storage devices 248. In such examples, determining the resource cost associated with executing the task may be based at least in part on an amount of energy required to execute the task.

As an example, if the capacity of energy storage devices 248 is 2500 milliampere hours (mAH) and the charge level is 100%, scheduler module 222 may determine that the total amount of resources available for executing tasks is 500 GRUs. In another example, if the capacity of energy storage devices 248 is 5000 mAH and the charge level is 100%, scheduler module 222 may determine that the total amount of resources available for executing tasks is 1000 GRUs. In yet another example, if the capacity of energy storage devices 248 is 2000 mAH and the charge level is 50%, scheduler module 222 may determine that the total amount of resources available for executing tasks is 100 GRUs. In yet another example, if the capacity of energy storage devices 248 is 2000 mAH and the charge level is 100%, scheduler module 222 may determine that the total amount of resources available for executing tasks is 200 GRUs.

As the charge level of energy storage devices 248 decreases, scheduler module 222 may adjust the amount of resources available for each application of applications 208 to prevent premature depletion of energy storage devices 248. In some examples, scheduler module 222 may adjust a base amount of resources available (e.g., the initial amount of resources available for each application of applications 208 when energy storage devices 248 have been fully charged) using a modifier associated with the current charge level of energy storage devices 248. For instance, if a charge level of energy storage devices 248 decreases from 100% to 75%, scheduler module 222 may multiply the base amount of GRUs available to each application of applications 208 by the current charge level of 75%, in this way potentially reducing the number of tasks that scheduler module 222 may schedule in accordance with techniques of this disclosure.

In some examples, scheduler module 222 may determine the total amount of resources available for executing tasks based on the number of applications 208 installed at computing device 200. For example, if 3 applications are installed at computing device 200, scheduler module 222 may determine that the total amount of resources available for executing tasks is 300 GRUs. In another example, if 6 applications are installed at computing device 200, scheduler module 222 may determine that the total amount of resources available for executing tasks is 600 GRUs. It should be understood that relationships between the total amount of resources available and the number of applications 208 installed at computing device 200 other than a linear relationship are contemplated by this disclosure. For example, the relationship may be exponential.

As the total amount of resources available for executing tasks may be fixed, if scheduler module 222 allocates too many resources to a set of applications 208, scheduler module 222 may be unable to allocate resources to applications not belonging to that set for those applications to request the execution of tasks. To address this scenario, each application of applications 208 may have a respective maximum limit of resources available such that scheduler module 222 cannot increase the amount of resources available to an application above the respective maximum limit. Additionally or alternatively, scheduler module 222 may periodically decrease the amount of resources available to each application of applications 208 by respective amounts, in this way “consuming” the resources, and redistribute the consumed resources in accordance with techniques of this disclosure. As an example, scheduler module 222 may consume, on a daily basis, a portion (e.g., 50%) of the GRUs available to each application above the respective initial amount of resources available.

Scheduler module 222 may increase the amount of resources available for each application of applications 208 when computing device 200 (and more specifically, energy storage devices 248) is charging. In some examples, scheduler module 222 may increase the amount of resources available for the respective applications at respective rates when computing device 200 is charging. For example, if a first application is not frequently used, a second application is somewhat frequently used, and a third application is frequently used, scheduler module 222 may allocate 10 GRUs/hour (hr) to the first application when computing device 200 is charging, 50 GRUs/hr to the second application when computing device 200 is charging, and 100 GRUs/hr to the third application when computing device 200 is charging.

In some examples, responsive to device state module 224 determining that computing device 200 is charging, scheduler module 222 may reset a respective current amount of resources available for each application from applications 208 to the respective initial amount of resources available for each application of applications 208. For example, scheduler module 222 may reset the respective current amount of resources available to the respective initial amount of resources available when energy storage devices 248 have been fully charged. Scheduler module 222 may gradually increase resources to the respective applications at respective rates until the respective current amount of resources has been reset to the respective initial amount of resources available. In some instances, scheduler module 222 may even increase the respective current amount of resources available above the respective initial amount of resources available (e.g., based on the priority of the task as indicated by historical usage rate, importance of the task, etc.).

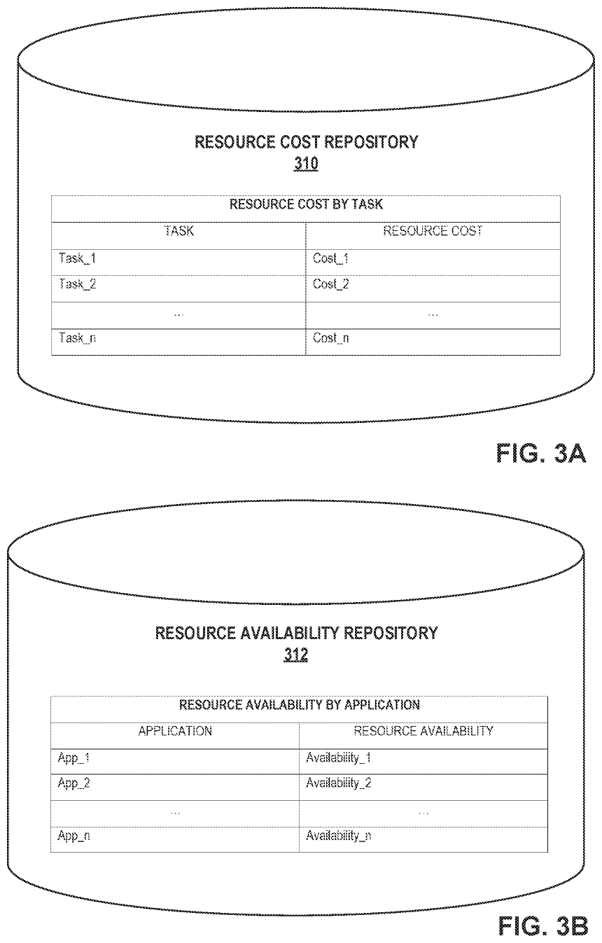

FIGS. 3A and 3B are conceptual diagrams illustrating a resource cost repository 310 and a resource availability repository 312 in accordance with techniques of this disclosure. Resource cost repository 310 of FIG. 3A is described below as an example of resource cost repository 210 illustrated in FIG. 2. Similarly, resource availability repository 312 of FIG. 3B is described below as an example of resource availability repository 212 illustrated in FIG. 2.

As shown in FIGS. 3A and 3B, resource cost repository 310 and resource availability repository 312 include a resource cost by application data structure (“RCA data structure”) and a resource availability by application data structure (“RAA data structure”), respectively. The RCA data structure may associate each task with information indicating the resource cost for the task. For example, the RCA data structure may associate a first task with a first resource cost, a second task with a second resource cost, etc. The RAA data structure may associate each task with information indicating the amount of resources available for each application for executing tasks. For example, the RAA data structure may associate a first application with a first amount of resources available, a second application with a second amount of resources available, etc.

A resource allocation module, such as resource allocation module 206, may allocate resources based on the information from the RCA data structure and the RAA data structure. For example, scheduler module 222 may determine the resource cost based on the information from the RCA data structure and the amount of resources available based on the information from the RAA data structure. At least a portion of the information from the RCA data structure may pertain to factors affecting resource cost, including, but not limited to, a state of the computing device, whether the task is a foreground task or a background task, and whether the task was initiated in response to a user input. For example, a portion of the information from the RCA data structure may include modifiers associated with the various factors that scheduler module 222 may use to adjust a base value for the resource cost associated with a task. As an example, a modifier associated with an exact alarm (e.g., an alarm that triggers at a specific time or in response to a specific condition) may be a multiplier of 1.1, which may result in scheduler module 222 increasing the resource cost associated with the task by 10%. In another example, a modifier associated with an inexact alarm (e.g., an alarm that, to some extent, may delay triggering to increase the likelihood of triggering when resources are less scarce, such as when computing device 200 is charging, when Wi-Fi® is available, etc.) may be a modifier of 0.9, which may result in scheduler module 222 decreasing the resource cost associated with the task by 10%.

Similarly, at least a portion of the information from the RAA data structure may pertain to factors affecting resource availability, including, but not limited to, the state of the computing device, a priority of the task, a frequency of the application requesting the task malfunctioning (e.g., the task timing-out, the application crashing, or other undesirable or unintended behavior), and a user input terminating execution of the application. For example, a portion of the information from the RAA data structure may include modifiers associated with the various factors that scheduler module 222 may use to adjust a base value for the amount of resources available for a task and/or a rate at which scheduler module 222 allocates resources to the application requesting the task. As an example, a modifier associated with a high frequency of a task timing-out may be a multiplier of 0.5, which may result in scheduler module 222 decreasing the amount of resources available for the task by 50% or decreasing the rate at which scheduler module 222 allocates resources to the application requesting the task by 50%.

A scheduler module may determine the resource cost based on a state of the computing device. For instance, scheduler module 222 may determine that a resource cost associated with a task is a first amount if computing device 200 is charging, a second amount if computing device 200 is not charging, and a third amount if computing device 200 is battery saving. The first amount may be different from the second amount and the third amount. For example, the first amount may be less than the second amount and the third amount. In yet another example, the first amount may be less than the second amount, and the second amount may be less than the third amount.

For instance, if device state module 224 determines that computing device 200 is charging, scheduler module 222 may determine that the resource cost associated with a task requested by an application is 0 GRUs. In another example, if device state module 224 determines that computing device 200 is not charging, scheduler module 222 may determine that the resource cost associated with the task is 100 GRUs. In yet another example, if device state module 224 determines that computing device 200 is battery saving, scheduler module 222 may determine that the resource cost associated with the task is 150 GRUs.

Additionally or alternatively, the scheduler module may determine the resource cost based on whether a task is a foreground task or a background task. For example, the scheduler module may determine that a resource cost associated with a task is a first amount if the task is a foreground task and a second amount if the task is a background task. The first amount may be different from the second amount. For example, the first amount may be less than the second amount.

As an example, if a task requested by an application is a foreground task, scheduler module 222 may determine that the resource cost associated with the task is 10 GRUs. If instead the task is a background task, scheduler module 222 may determine that the resource cost associated with the task is 20 GRUs. In this example, the base value of the task may be 15, and the modifier for the task being performed in the foreground may be a multiplier of approximately 0.67, and the modifier for the task being performed in the background may be a multiplier of approximately 1.33.

In some examples, the scheduler module may determine the resource cost based on whether the task was initiated in response to a user input. For example, the scheduler module may determine that a resource cost associated with a task is a first amount if the task was initiated in response to a user input and a second amount if the task was not. The first amount may be different from the second amount. For example, the first amount may be less than the second amount.

For example, if a task requested by an application was initiated in response to a user input, scheduler 222 may determine that the resource cost associated with the task is 0 GRUs. However, if the task was not initiated in response to a user input, scheduler 222 may determine that the resource cost associated with the task is 75 GRUs.

A scheduler module may determine the amount of resources available for executing the task based on a priority of the task, the priority of the task indicating one or more of a historical usage rate (e.g., how often a user of computing device 200 interacts with the application) of the application or an importance of the task (e.g., an alarm, a calendar reminder, etc.). For instance, if a first application has a relatively high historical usage rate and/or importance, the first application may have a relatively large initial amount of resources available for executing the task and/or scheduler module 222 may increase the amount of resources available for executing the task relatively quickly (e.g., when computing device is charging). On the other hand, if a second application has a relatively low historical usage rate and/or importance, the second application may have a relatively small initial amount of resources available for executing the task and/or scheduler module 222 may increase the amount of resources available for executing the task relatively slowly.

In some examples, the scheduler module may determine the amount of resources available for executing the task based at least in part on one or more of a frequency of the application requesting the task malfunctioning (e.g., the task timing-out, the application crashing, or other undesirable or unintended behavior), or a user input terminating execution of the application. For example, if a frequency of a task timing-out is low, the amount of resources available for executing the task may be relatively large. If, however, the frequency of the task timing-out is high, the amount of resources available for executing the task may be relatively small. In examples where the user provides user input terminating execution of an application (which may indicate that the user does not desire the application to consume resources of computing device 200), scheduler module 222 may not allocate more resources to the application until the user initializes or otherwise interacts with the application again.

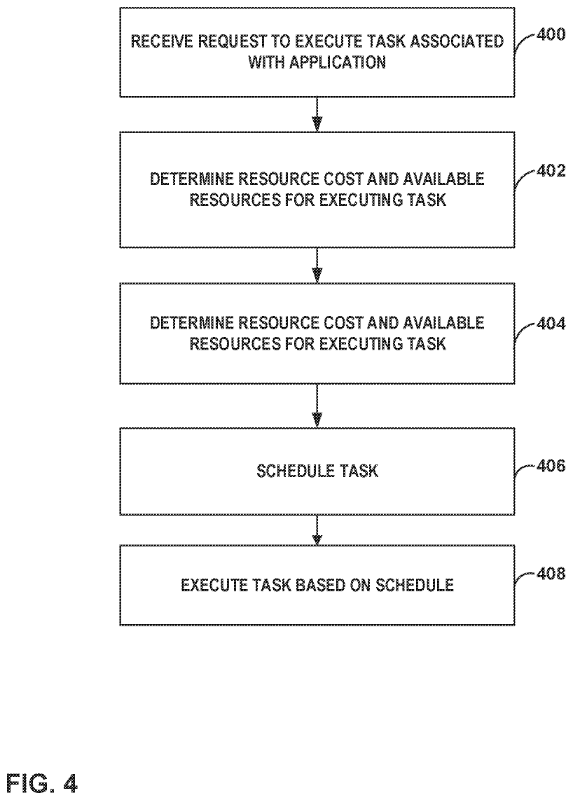

FIG. 4 is a flowchart illustrating an example operation of the computing device in accordance with techniques of this disclosure. Although primarily described with respect to computing device 100 of FIG. 1, it should be understood that the techniques illustrated by FIG. 4 may be applied by any of the computing devices disclosed herein. In the example of FIG. 4, resource allocation module 106 may receive a request for OS 104 to execute a task (400). For example, an entertainment application may send a request to resource allocation module 106 for OS 104 to execute a background task of automatically downloading a movie.

Responsive to receiving a request for OS 104 to execute a task associated with one of applications 108, resource allocation module 106 may determine a resource cost associated with executing the task and an amount of resources available for executing the task (402). Resource allocation module 106 may obtain the resource cost for the task from resource cost repository 110. Resource allocation module 106 may obtain the amount of resources available for the task from resource availability repository 112.

Resource allocation module 106 may compare the resource cost associated with executing the task with the amount of resources available for executing the task (404). Resource allocation module 106 may schedule the task to be executed at computing device 100 (406). OS 104 may execute the task based on the schedule (408) in accordance with techniques of this disclosure.

In some examples, resource allocation module 106 may schedule the task to be executed at computing device 100 in response to determining that the amount of resources available for executing the task is sufficient given the resource cost associated with executing the task. In cases where resource allocation module 106 determines that there is an insufficient amount of resources available, resource allocation module 106 may not schedule the task and OS 104, in turn, may not execute the task. In some examples, computing device 100 may output notification 116 via UIC 102 when a task is not scheduled (and not executed) due to insufficient amount of resources available.

For instance, an entertainment application may send a request to resource allocation module 106 for OS 104 to execute a background task of automatically downloading a movie. Resource allocation module 106 may access the data structure stored in resource cost repository 110 and determine that the resource cost is 50 GRUs. Resource allocation module 106 may access the data structure stored in resource availability repository 112 and determine that the amount of resources available for executing this task is 25 GRUs. Accordingly, resource allocation module 106 may not schedule the background task of automatically downloading a movie because the resource cost of 50 GRUs is greater than the amount of resources available of 25 GRUs. Additionally, computing device 100 may output notification 116 communicating that the background task of automatically downloading a movie failed to schedule and execute due to an insufficient amount of resources available.

In other examples, resource allocation module 106 may schedule the task to be executed at computing device 100 irrespective of whether the amount of resources available for executing the task is sufficient. However, OS 104 may only execute, based on the schedule, the task in response to resource allocation module 106 determining that the amount of resources available for executing the task is sufficient given the resource cost associated with executing the task. Computing device 100 may output notification 116 via UIC 102 when a task is not executed due to insufficient amount of resources available.

After resource allocation module 106 denies (or, in some examples, defers) the request by an application for OS 104 to execute the task, the application may send a subsequent request to resource allocation module 106. In some examples, prior to the application sending the subsequent request, resource allocation module 106 may increase the amount of resources available for each application of applications 108. For example, responsive to resource allocation module 106 determining that the computing device 100 is charging and prior to the application sending the subsequent request, resource allocation module 106 may increase the amount of resources available for each application of applications 108 at respective rates until the amount of resources available for the application is equal to or greater than the resource cost associated with a task requested by the application (i.e., the resource cost is less than or equal to the amount of resources available). Thus, if the application sends the subsequent request, resource allocation module 106 may schedule and OS 104 may execute the task.

For instance, continuing the above example where resource allocation module 106 denied scheduling the background task of automatically downloading a movie because the resource cost of 50 GRUs is greater than the amount of resources available of 25 GRUs, OS 104 may determine that the computing device 100 is charging. Responsive to this determination, resource allocation module 106 may increase the amount of resources available for the entertainment application. In some examples, resource allocation module 106 may reset the current amount of resources available of 25 GRUs to the initial amount of resources, which may be 100 GRUs. Accordingly, if the entertainment application sends a subsequent request to resource allocation module 106 for automatically downloading a movie, resource allocation module 106 may schedule and OS 104 may execute the task.

In some examples, resource allocation module 106 may schedule the task but defer execution until there are sufficient resources available. In such examples, resource allocation module 106 may store the request and respond to the request by allocating an amount of resources for executing the task when the resource cost associated with the task is less than or equal to the amount of resources available for the application. For example, responsive to resource allocation module 106 determining that the computing device 100 is charging, resource allocation module 106 may increase the amount of resources available for each application of applications 108 at respective rates such that the amount of resources available for the application is eventually equal to or greater than the resource cost associated with the deferred task requested by the application (i.e., the resource cost is less than or equal to the amount of resources available). Responsive to the resource cost associated with the deferred task being less than or equal to the amount of resources available for the application, OS 104 may execute, based on the schedule, the deferred task.

This disclosure includes the following examples.

Example 1: A method includes receiving, by an operating system executing at a computing device, a request for the operating system to execute a task associated with an application installed at the computing device; determining, by the operating system, a resource cost associated with executing the task; determining, by the operating system and based on the application, an amount of resources available for executing the task; scheduling, by the operating system, the task to be executed at the computing device; and responsive to determining that the amount of resources available for executing the task is sufficient given the resource cost associated with executing the task, executing, by the operating system and based on the schedule, the task.

Example 2: The method of example 1, wherein scheduling the task to be executed at the computing device is in response to determining that the amount of resources available for executing the task is sufficient given the resource cost associated with executing the task.

Example 3: The method of any of examples 1 and 2, further includes determining, by the operating system, a total amount of resources available for executing tasks; and determining, by the operating system and based on the total amount of resources, a respective initial amount of resources available for each application from a plurality of applications installed at the computing device, wherein determining the amount of resources available for executing the task is based on the respective amount of resources available for the application associated with the task and an amount of resources previously used by the application.

Example 4: The method of example 3, further includes determining, by the operating system, that the computing device is charging; and responsive to determining that the computing device is charging, resetting, by the operating system, a respective current amount of resources available for each application from the plurality of applications to the respective initial amount of resources available for each application from the plurality of applications.

Example 5: The method of any of examples 3 and 4, wherein determining the total amount of resources available for executing tasks is based on one or more of a capacity of a battery of the computing device and a charge level of the battery of the computing device, and wherein determining the resource cost associated with executing the task is based at least in part on an amount of energy required to execute the task.

Example 6: The method of any of examples 1 through 5, wherein determining the amount of resources available for executing the task is based on a priority of the task, the priority of the task indicating one or more of a historical usage rate of the application or an importance of the task.

Example 7: The method of any of examples 1 through 6, wherein determining that the amount of resources available to execute the task is sufficient given the resource cost associated with the task includes determining that the resource cost associated with executing the task is less than or equal to the amount of resources available for executing the task.

Example 8: The method of any of examples 1 through 7, wherein determining the resource cost associated with the task includes: determining, by the operating system, a state of the computing device; responsive to determining that the state of the computing device is charging, determining, by the operating system, that the resource cost associated with the task is a first amount; responsive to determining that the computing device is not charging, determining, by the operating system, that the resource cost associated with the task is a second amount; and responsive to determining that the computing device is battery saving, determining, by the operating system, that the resource cost associated with the task is a third amount, wherein the first amount is different from the second amount and the third amount.

Example 9: The method of any of examples 1 through 8, wherein determining the resource cost associated with the task includes: determining, by the operating system, whether the task is a foreground task or a background task; responsive to determining that the task is the foreground task, determining, by the operating system, that the resource cost associated with the task is a first amount; and responsive to determining that the task is the background task, determining, by the operating system, that the resource cost associated with the task is a second amount, wherein the first amount is different from the second amount.

Example 10: The method of any of examples 1 through 9, wherein determining the resource cost associated with executing the task further includes: determining, by the operating system, whether the task was initiated in response to a user input; responsive to determining that the task was initiated in response to the user input, determining, by the operating system, that the resource cost associated with the task is a first amount; and responsive to determining that the task was not initiated in response to the user input, determining, by the operating system, that the resource cost associated with the task is a second amount, wherein the first amount is different from the second amount.

Example 11: The method of any of examples 1 through 10, wherein determining the amount of resources available for executing the task is based at least in part on one or more of a frequency of the application malfunctioning or a user input terminating execution of the application.

Example 12: A computing device includes one or more processors; a memory that stores an operating system and instructions that, when executed by the one or more processors, cause the one or more processors to: receive a request for the operating system to execute a task associated with an application installed at the computing device; determine a resource cost associated with executing the task; determine, based on the application, an amount of resources available for executing the task; schedule the task to be executed at the computing device; and responsive to determining that the amount of resources available to execute the task is sufficient given the resource cost associated with the task, execute, based on the schedule, the task.

Example 13: The computing device of example 12, wherein the instructions cause the one or more processors to schedule the task to be executed at the computing device in response to determining that the amount of resources available to execute the task is sufficient given the resource cost associated with the task.

Example 14: The computing device of any of examples 12 and 13, wherein the instructions, when executed by the one or more processors, further cause the one or more processors to: determine a total amount of resources available for executing tasks; and determine, based on the total amount of resources, a respective initial amount of resources available for each application from a plurality of applications installed at the computing device, wherein the instructions cause the one or more processors to determine the amount of resources available for executing the task based on the respective amount of resources available for the application associated with the task and an amount of resources previously used by the application.

Example 15: The computing device of example 14, wherein the instructions, when executed by the one or more processors, further cause the one or more processors to: determine that the computing device is charging; and responsive to determining that the computing device is charging, reset a respective current amount of resources available for each application from the plurality of applications to the respective initial amount of resources available for each application from the plurality of applications.

Example 16: The computing device of any of examples 14 and 15, wherein the instructions cause the one or more processors to determines the total amount of resources available for executing tasks based on one or more of a capacity of a battery of the computing device and a charge level of the battery of the computing device, and wherein the instructions cause the one or more processors to determine the resource cost associated with executing the task based at least in part on an amount of energy required to execute the task.

Example 17: The computing device of any of examples 12 through 16, wherein the instructions cause the one or more processors to determine the amount of resources available for executing the task based on a priority of the task, the priority of the task indicating one or more of a historical usage rate of the application or an importance of the task.

Example 18: The computing device of any of examples 12 through 17, wherein the instructions, when executed by the one or more processors, further cause the one or more processors to: determine, by the operating system, a state of the computing device; responsive to determining that the state of the computing device is charging, determine that the resource cost associated with the task is a first amount; responsive to determining that the computing device is not charging, determine that the resource cost associated with the task is a second amount; and responsive to determining that the computing device is battery saving, determine that the resource cost associated with the task is a third amount, wherein the first amount is different from the second amount and the third amount.

Example 19: A non-transitory computer-readable storage medium encoded with instructions that, when executed by one or more processors of a computing device, cause the one or more processors to: receive a request for an operating system of the computing device to execute a task associated with an application installed at the computing device; determine a resource cost associated with executing the task; determine, based on the application, an amount of resources available for executing the task; schedule the task to be executed at the computing device; and responsive to determining that the that the amount of resources available to execute the task is sufficient given the resource cost associated with the task, execute, based on the schedule, the task.

Example 20: The non-transitory computer-readable storage medium of example 19, wherein the instructions cause the one or more processors to schedule the task to be executed at the computing device in response to determining that the amount of resources available to execute the task is sufficient given the resource cost associated with the task.

Example 21: A computing device including means for performing any combination of the methods of examples 1-11.

Example 22: A non-transitory computer-readable storage medium encoded with instructions that, when executed by one or more processors, cause the one or more processors to perform any combination of the methods of examples 1-11.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
receiving, by an operating system executing at a computing device, a request for the operating system to execute a task associated with an application installed at the computing device;
determining, by the operating system, a resource cost associated with executing the task;
determining, by the operating system and based on the application, an amount of resources available for executing the task;
scheduling, by the operating system, the task to be executed at the computing device; and
responsive to determining that the amount of resources available for executing the task is sufficient given the resource cost associated with executing the task, executing, by the operating system and based on the schedule, the task.

2. The method of claim 1, wherein scheduling the task to be executed at the computing device is in response to determining that the amount of resources available for executing the task is sufficient given the resource cost associated with executing the task.

3. The method of claim 1, further comprising:
determining, by the operating system, a total amount of resources available for executing tasks; and
determining, by the operating system and based on the total amount of resources, a respective initial amount of resources available for each application from a plurality of applications installed at the computing device,
wherein determining the amount of resources available for executing the task is based on the respective amount of resources available for the application associated with the task and an amount of resources previously used by the application.

4. The method of claim 3, further comprising:
determining, by the operating system, that the computing device is charging; and
responsive to determining that the computing device is charging, resetting, by the operating system, a respective current amount of resources available for each application from the plurality of applications to the respective initial amount of resources available for each application from the plurality of applications.

5. The method of claim 3,
wherein determining the total amount of resources available for executing tasks is based on one or more of a capacity of a battery of the computing device and a charge level of the battery of the computing device, and
wherein determining the resource cost associated with executing the task is based at least in part on an amount of energy required to execute the task.

6. The method of claim 1, wherein determining the amount of resources available for executing the task is based on a priority of the task, the priority of the task indicating one or more of a historical usage rate of the application or an importance of the task.

7. The method of claim 1, wherein determining that the amount of resources available to execute the task is sufficient given the resource cost associated with the task comprises determining that the resource cost associated with executing the task is less than or equal to the amount of resources available for executing the task.

8. The method of claim 1, wherein determining the resource cost associated with the task comprises:
determining, by the operating system, a state of the computing device;
responsive to determining that the state of the computing device is charging, determining, by the operating system, that the resource cost associated with the task is a first amount;
responsive to determining that the computing device is not charging, determining, by the operating system, that the resource cost associated with the task is a second amount; and
responsive to determining that the computing device is battery saving, determining, by the operating system, that the resource cost associated with the task is a third amount, wherein the first amount is different from the second amount and the third amount.

9. The method of claim 1, wherein determining the resource cost associated with the task comprises:
determining, by the operating system, whether the task is a foreground task or a background task;
responsive to determining that the task is the foreground task, determining, by the operating system, that the resource cost associated with the task is a first amount; and
responsive to determining that the task is the background task, determining, by the operating system, that the resource cost associated with the task is a second amount, wherein the first amount is different from the second amount.

10. The method of claim 1, wherein determining the resource cost associated with executing the task further comprises:
determining, by the operating system, whether the task was initiated in response to a user input;
responsive to determining that the task was initiated in response to the user input, determining, by the operating system, that the resource cost associated with the task is a first amount; and
responsive to determining that the task was not initiated in response to the user input, determining, by the operating system, that the resource cost associated with the task is a second amount, wherein the first amount is different from the second amount.

11. The method of claim 1, wherein determining the amount of resources available for executing the task is based at least in part on one or more of a frequency of the application malfunctioning or a user input terminating execution of the application.

12. A computing device comprising:
one or more processors;
a memory that stores an operating system and instructions that, when executed by the one or more processors, cause the one or more processors to:
receive a request for the operating system to execute a task associated with an application installed at the computing device;
determine a resource cost associated with executing the task;
determine, based on the application, an amount of resources available for executing the task;
schedule the task to be executed at the computing device; and
responsive to determining that the amount of resources available to execute the task is sufficient given the resource cost associated with the task, execute, based on the schedule, the task.

13. The computing device of claim 12, wherein the instructions cause the one or more processors to schedule the task to be executed at the computing device in response to determining that the amount of resources available to execute the task is sufficient given the resource cost associated with the task.

14. The computing device of claim 12, wherein the instructions, when executed by the one or more processors, further cause the one or more processors to:
determine a total amount of resources available for executing tasks; and
determine, based on the total amount of resources, a respective initial amount of resources available for each application from a plurality of applications installed at the computing device,
wherein the instructions cause the one or more processors to determine the amount of resources available for executing the task based on the respective amount of resources available for the application associated with the task and an amount of resources previously used by the application.

15. The computing device of claim 14, wherein the instructions, when executed by the one or more processors, further cause the one or more processors to:
determine that the computing device is charging; and
responsive to determining that the computing device is charging, reset a respective current amount of resources available for each application from the plurality of applications to the respective initial amount of resources available for each application from the plurality of applications.

16. The computing device of claim 14,
wherein the instructions cause the one or more processors to determines the total amount of resources available for executing tasks based on one or more of a capacity of a battery of the computing device and a charge level of the battery of the computing device, and
wherein the instructions cause the one or more processors to determine the resource cost associated with executing the task based at least in part on an amount of energy required to execute the task.

17. The computing device of claim 12, wherein the instructions cause the one or more processors to determine the amount of resources available for executing the task based on a priority of the task, the priority of the task indicating one or more of a historical usage rate of the application or an importance of the task.

18. The computing device of claim 12, wherein the instructions, when executed by the one or more processors, further cause the one or more processors to:
determine, by the operating system, a state of the computing device;
responsive to determining that the state of the computing device is charging, determine that the resource cost associated with the task is a first amount;
responsive to determining that the computing device is not charging, determine that the resource cost associated with the task is a second amount; and
responsive to determining that the computing device is battery saving, determine that the resource cost associated with the task is a third amount, wherein the first amount is different from the second amount and the third amount.

19. A non-transitory computer-readable storage medium encoded with instructions that, when executed by one or more processors of a computing device, cause the one or more processors to:
receive a request for an operating system of the computing device to execute a task associated with an application installed at the computing device;
determine a resource cost associated with executing the task;
determine, based on the application, an amount of resources available for executing the task;
schedule the task to be executed at the computing device; and
responsive to determining that the that the amount of resources available to execute the task is sufficient given the resource cost associated with the task, execute, based on the schedule, the task.

20. The non-transitory computer-readable storage medium of claim 19, wherein the instructions cause the one or more processors to schedule the task to be executed at the computing device in response to determining that the amount of resources available to execute the task is sufficient given the resource cost associated with the task.
